(19) United States
(12) Patent Application Publication
(10) Pub. No.: US 2013/0045098 A1
(43) Pub. Date: Feb. 21, 2013

(54) Cyclic Pitch Control System for Wind Turbine Blades

(71) Applicant: Nathaniel Brook Taylor, Santa Barbara, CA (US)

(72) Inventor: Nathaniel Brook Taylor, Santa Barbara, CA (US)

(73) Assignee: Clipper Windpower, LLC, Carpinteria, CA (US)

(21) Appl. No.: 13/212,646

(22) Filed: Aug. 18, 2011

(51) Int. Cl. F03D 7/04

(52) U.S. Cl. 416/1

(57) ABSTRACT

In a wind turbine, an open loop control algorithm for incrementally or positively adjusting the pitch angles of individual rotor blades may be used to increase spacing between the base of the turbine tower and an approaching blade tip. As each rotating blade passes in front of the tower base, a minimum clearance distance may be assured to avoid blade tip strikes of the base. In accordance with at least one embodiment of the control algorithm, as each blade approaches the tower base, it may be feathered to reduce its power loading, and to facilitate increased clearance beyond the normal unloading or feathering produced by the so-called tower shadow effect. To offset resultant loss of torque, the remaining blades may be correspondingly pitched toward power, i.e. into the wind, to balance and/or smooth out the overall rotor torque curve, and thus to avoid torque ripples.

### TECHNICAL FIELD

This disclosure relates to control systems for managing operations of wind turbines. More particularly, the disclosure provides control algorithms for selectively varying the pitch angle of individual turbine rotor blades to increase the distance between a blade tip and the tower as the blade tip crosses in front of the tower.

### BACKGROUND

Changing the pitch of the rotor blades of a utility scale wind turbine is commonly used as a primary control mechanism. The blades are pitched toward a power pitch position (i.e., at a lower pitch angle or into greater influence of the wind) to increase the amount of wind energy captured by the rotor, in turn increasing torque on the main shaft of the wind turbine to drive electric generators. The blades are pitched toward a feather position (at a higher pitch angle or away from influence of the wind) to decrease wind energy captured by the rotor, and to decrease torque on the main shaft.

The reaction torque created by the electrical generators which are driven by the main shaft (often via a gearbox) is another controlled aspect of a utility-scale wind turbine. Balancing the rotor torque against the generator torque (opposed moments) on the main shaft is one common method of controlling shaft speed.

Collective blade pitching has been and remains a common method of pitching the rotor blades, although individual blade pitching strategies have been more recently developed. Collective pitching generally involves all of the blades simultaneously being pitched to the same pitch angle. Individual blade pitching provides for adjustment of individual rotor blades to customized pitch angles, independently of the other blades.

Individual blade pitch control strategies have been proposed chiefly for balancing loads on the rotor blades across the swept area of the rotor and maximizing power output. In rotor swept areas in which localized or spot wind speeds may be lower than mean wind speeds, the blades may be transiently pitched toward power positions to produce amounts of power equal to that being produced over other regions of the rotor area. Conversely, where the spot wind speeds are higher than mean wind speeds across the rotor, the blades may be pitched toward feather positions. For the various individual blade pitch control strategies which have been proposed, the purpose of each and the focus has been on load balancing, smoothing out power fluctuations, and reductions of maximum loads. None of these proposed strategies have suggested an individual blade pitch control strategy for increasing the distance between a blade tip and the tower as the blade tip crosses in front of the tower.

### SUMMARY OF THE DISCLOSURE

This disclosure proposes open loop control methods for increasing blade tip to tower clearance by pitching individual blades toward their feathered position as each blade tip passes in front of the tower.

In one aspect of the disclosure, a method to enhance the tower shadow effect, i.e. the normal tendency for each blade to produce less power and to actually unload or bend away from the tower is provided. The tower shadow effect results from lower wind speeds that normally exist immediately in front of the tower. As a result, a pitch control algorithm adapted to pitch an individual blade toward its feathered position as its tip advances toward the tower will cause that blade to unload and/or to spring away from the tower by an even greater distance to thus create a greater blade tip to tower clearance.

Another aspect of this disclosure is a further enhancement of overall wind turbine performance by superimposing an open loop pitch control algorithm on each individual blade, based primarily on the azimuthal position of that blade. The open loop pitch control algorithm may be added to any pre-existing individual pitch command strategies, even if closed loop, such as in situations wherein the blades might be otherwise pitched to accommodate conditions of wind shear, for example.

In yet another aspect of the disclosure, an azimuthal position-based open loop individual blade pitch control algorithm may be complemented and/or otherwise supplemented by corresponding pitch angle adjustments to the other (non-tower-crossing) blades, including having such other blades being pitched toward their power positions whenever the tower-crossing blade is being moved toward its feather position. This would achieve a more balanced, continuous torque and power output of the rotor during each revolution thereof.

### BRIEF DESCRIPTION OF THE DRAWINGS

FIG. 1 is an elevational view of a wind turbine that embodies the disclosed control algorithm and related methodology, displayed to show one of the spinning rotor blades approaching the tower base.

FIG. 2 is an elevational view of the same wind turbine, with the tower-crossing blade instantaneously passing over the centerline of the tower base.

FIG. 3 is an elevational view of the same wind turbine, with the same blade having just passed by the tower base.

FIG. 4 is a graph displaying variation of blade pitch angle as a function of the azimuthal position of a tower-crossing blade, as may be provided by an exemplary control algorithm.

FIG. 5 is an elevational view of the same wind turbine, but embodying an alternate control algorithm and methodology.

### DETAILED DESCRIPTION

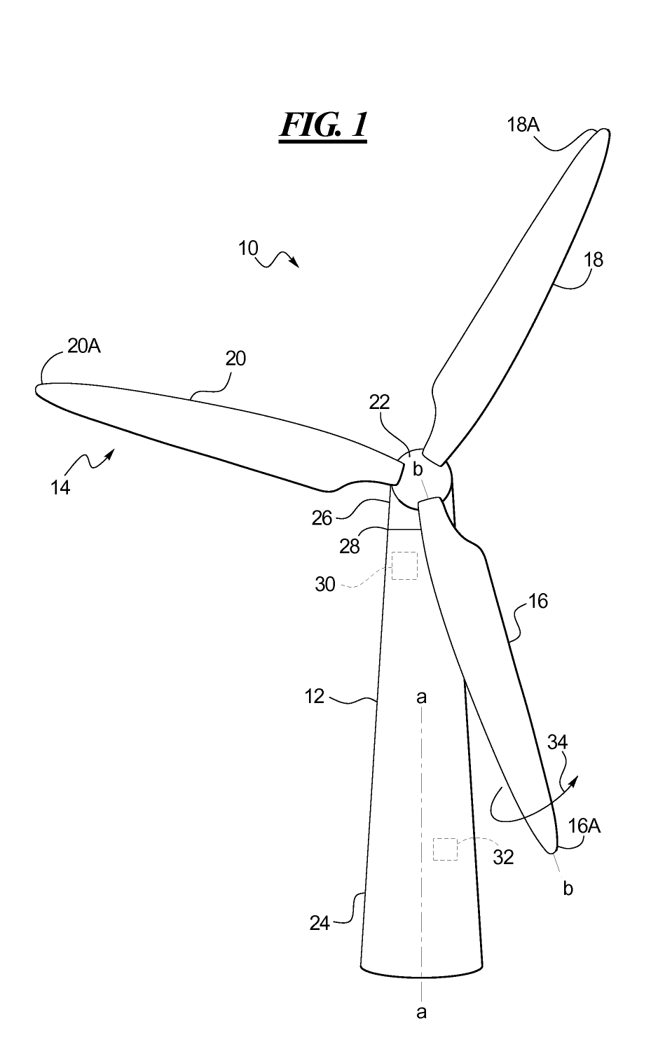

Referring initially to FIG. 1, an exemplary wind turbine 10 is schematically shown in accordance with at least one embodiment of the present disclosure. While all components of the wind turbine are not shown or described herein, the wind turbine 10 may include a vertically standing tower 12 having an axis “a-a”, and supporting a rotor 14. The rotor is defined by a collective plurality of equally spaced rotating blades 16, 18, and 20, each connected to and radially extending from a hub 22, as shown. The blades 16, 18, 20 may be rotated by wind energy such that the rotor 14 may transfer such energy via a main shaft (not shown) to one or more generators (not shown). Those skilled in the art will appreciate that such wind-power driven generators may produce commercial electric power for transmission to an electric grid (not shown). Those skilled in the art will appreciate that a plurality of such wind turbines may be effectively employed on a so-called wind turbine farm to generate a significant amount of electric power. Although the disclosed embodiments focus on wind only, this disclosure is pertinent to fluids generally, including other gases and even liquids such as water, that may be used to drive similar turbine structures.

In the embodiments described herein, each of the blades 16, 18, 20 is individually adjustable, i.e. it can be pitched about its radial axis “b-b” (shown only with respect to blade 16 for simplicity), independently of the pitch angle of any other blade. Generally, blades 16, 18, and 20 can be individually pitched toward a feathered position in which the blade produces little or no torque about the hub 22, or toward a power position in which the blade produces a maximum amount of torque about the hub.

A prime motivation of this disclosure relates to the avoidance of blade tip strikes against abase section 24 of tower 12, as such strikes can result in complete destruction of the wind turbine structure. It will be appreciated by those skilled in the art that during operation of the wind turbine, and because the blades 16, 18, 20 are long and flexible and positioned to capture energy from wind to convert same to rotor torque, the blade tips 16A, 18A, and 20A may on occasion be deflected toward the base 24. It will further be appreciated by those skilled in the art that various wind and air movements including wind gusts may impart transient forces on the blade tips 16A, 18A, and 20A, producing higher than normal tip deflections. As a consequence of such transient tip deflections, wind turbines are designed to ensure that adequate margins of safety exist to reduce actual amounts of tip deflection that might cause the tips 16A, 18A, and 20A to strike the base 24. Such margins of safety are normally ensured by designing the blades to be stiff, so as to avoid excessive deflections, or to control operation of the wind turbine so that operational conditions which might result in a blade tip to tower strike are avoided. Also, by slightly tilting the rotational axis of the rotor 14 from a true horizontal orientation to an orientation that is slightly inclined, the blade tips 16A, 18A, and 20A can be spaced a greater distance away from the tower base 24 when any given blade is positioned at the six o'clock position, or in alignment with axis a-a.

In accordance with this disclosure, to further counteract such strikes, a control system 30 (shown schematically at the upper portion of the tower 12) may be employed to feather in real-time each individual blade approaching the base 24, to reduce its deflection in the direction of the tower 12, thus providing an additional margin of safety against blade tip to tower strikes.

Continuing reference to FIG. 1, the hub 22 is attached through a main shaft (not shown) to a nacelle 26, as shown. The nacelle 26 is adapted to revolve about axis a-a, at the top of the tower 12 at the interface 28 of the tower 12 and nacelle 26. Such turntable like nacelle movement is within a generally horizontal plane (not shown) that passes through the interface 28, and is managed by a yaw control system (not shown). The rotatable nacelle 26 may be adapted to freely turn, so as to be able to position the rotor directly perpendicularly to any prevailing winds, and to thereby optimize power generation under conditions of shifting winds.

An azimuthal encoder 32 (shown schematically on the base 24) may be adapted to be in electronic communication with the control system 30. The azimuthal encoder 32 may sense the approach and proximity of any given blade tip 16A, 18A, 20A to the base 24, and respond by sending an appropriate signal to the control system 30. The control system 30 may respond in turn by feathering the single approaching blade 16A (in FIG. 1), at least in part as a function of the encoder-sensed azimuthal position of that blade. A blade torque arrow 34 about the blade tip 16A indicates that the blade 16 is being rotated about axis “b-b” toward a feather position by the control system 30 as the blade approaches the tower base 24. Although proximity sensing via an encoder 32 mounted at the bottom of the base 24 is suggested above, this is merely exemplary. The encoder 32 may also be positioned between the rotor and the nacelle, rather than on the base 24, in which case the encoder 32 may be calibrated to specific azimuthal positions of each blade. The encoder 32 may be any sensor capable of sensing the current or real-time azimuthal positions of the blades 16, 18, and 20, or sensing the approach of blade tips 16A, 18A, and 20A to the base 24.

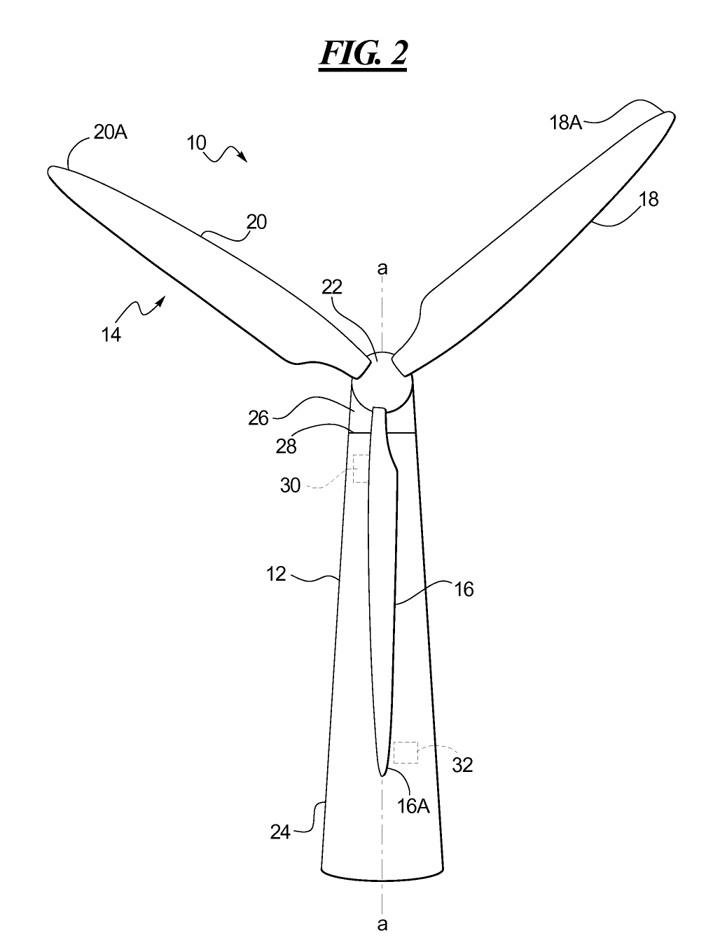

Referring now to FIG. 2, the blade 16 and hence the blade tip 16A is at a traditionally referenced six o′clock position, or instantaneously positioned in-line with axis a-a, which coincides with the vertical centerline of the tower 12. It will be noted that in such position the blade 16 is feathered, i.e. edged into the wind. As earlier stated, the six o′clock position is the position of the so-called tower shadow effect, in which the effect of the wind on the tower-crossing blade 16 is already minimized As such, the feathering of the blade 16 works with, rather than against, the tower shadow effect to further increase the clearance between the blade tip and the tower. Finally, and just as a point of azimuthal reference, the six o'clock position of the blade represents 180° of clockwise rotation from the top or 12 o'clock position, which represents the 0° and 360° blade position.

The magnitude of the blade feathering or pitch angle adjustment can be selected according to the amount of additional tower clearance or reduced deflection desired, and may also depend upon the particular design of the wind turbine, particularly the blades. The amount of blade feathering or pitch angle adjustment may also depend upon wind speed, rotor speed, nominal pitch angle or demand, wind turbine power output, and other operational factors. For example, for a certain turbine and during certain operation conditions, the peak magnitude of the pitch angle adjustment could be around 3° . If the wind turbine is normally operated at a 5° pitch angle at these operational conditions (the 5° pitch angle is referred to as the nominal pitch demand or command), then the control system 30 may cause an incremental, or positive, pitch angle adjustment of 3°, resulting in an actual pitch angle for the tower crossing blade of 8°. At 8° of pitch angle compared to 5°, the blade will be unloaded and produce less power and torque, but will also experience less deflection in the direction of tower 12.

The peak magnitude of the pitch angle adjustment could be higher or lower than 3° at different operation conditions. Likewise, the pitch rate (how quickly the blade pitches), and the azimuthal positions at which the pitch adjustment toward feather begins and the pitch adjustment back toward power ends, may all be adjusted by the control system 30, as a function of operational factors such as wind speed, rotor speed, nominal pitch angle or demand, wind turbine power output, etc.

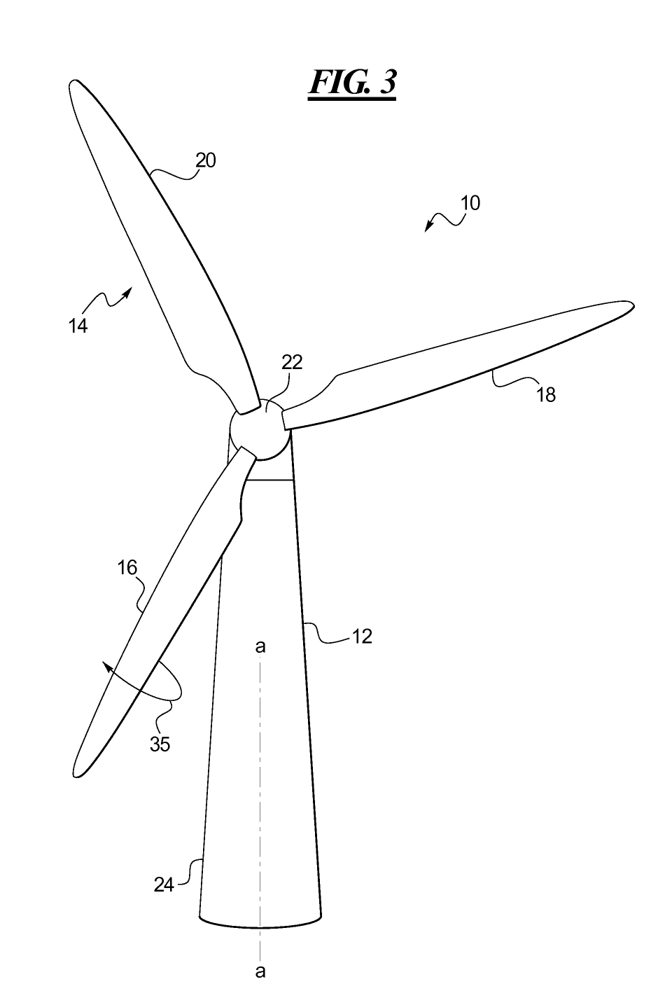

In FIG. 3, the blade 16 is instantaneously shown to have advanced past the axis a-a, wherein communication of the azimuthal encoder 32 with the control system 30 may be effective to return the blade 16 toward its power pitch position, as indicated by the blade torque arrow 35. It will be appreciated that the same control system 30 may be adapted to initiate both the feathering and the return to power pitch responses at predetermined azimuthal positions. The control system 30 may function as a simple open loop algorithm, to the extent that no feedback of any other real-time variable is required for its effectiveness.

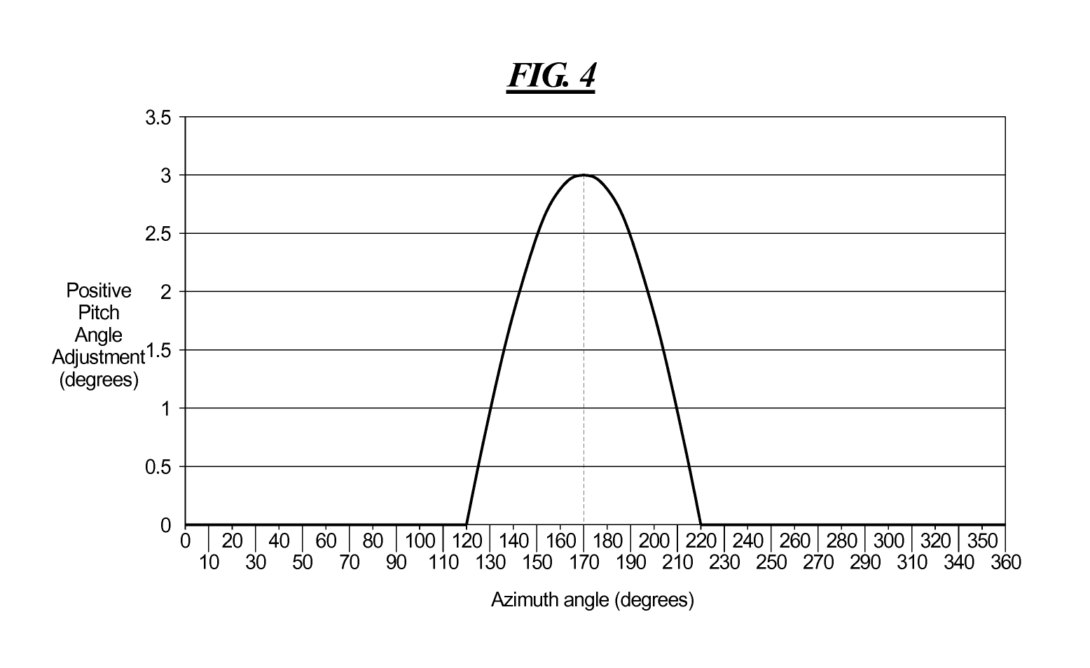

FIG. 4 is a graph depicting the positive pitch angle adjustment relative to the azimuthal position of the blade, with an exemplary positive pitch angle adjustment profile having a peak of 3°. As the three blades 16, 18, and 20 of the wind turbine 10 are rotating and producing power, a nominal pitch demand is generated by the control system 30 to pitch the blades to an appropriate power pitch angle, for example between 5° and 10°. In a typical wind turbine control system, the nominal power pitch angle demand is provided to the pitch control system, which may further process the demand to smooth transitions and achieve other beneficial effects before actually controlling pitch angle actuation. The azimuthal encoder 32 communicates an azimuthal position signal for each blade to the control system 30, which uses this signal to generate additional commands of incremental pitch, as appropriate. Such commands of incremental pitch may be achieved by consulting a look-up table, by using a mathematical function, or any other appropriate methodology.

With reference to the exemplary pitch angle adjustment profile in FIG. 4, as the azimuthal position of the tower-crossing blade approaches the base 24, for example within a range of 90 to 180°, or more particularly within a range of 100 to 160°, or more particularly at about 120° in the example provided in FIG. 4, a small, incremental pitch angle adjustment command is first provided. Those skilled in the art will appreciate that even though the tower-crossing blade actually passes the tower base 24 precisely at the 180° position, some amount of lead time, or advance, such as the 10° advance angle of the disclosed example, may be provided to accommodate lag time between change in blade pitch angle and reduced blade deflection. Thus, as the blade pitches out of the wind and unloads, a small amount of time is required for the blade deflection to decrease so that the blade moves away from the tower. As such, in the disclosed example the full amount of pitch angle adjustment will be completed by the time the blade has reached the 170° position. As the blade passes the azimuthal position where the peak pitch angle adjustment occurs, the pitch angle adjustment is then reduced, i.e. the blade is powered back up, starting at a point beginning at 170° in the example of FIG. 4, until a pre-determined termination point is reached, for example at a point within the azimuthal range of 180 to 270°, or more particularly within a range of 200 to 260°, or more particularly at about 220° in the disclosed example.

The azimuthal position and the shape of the incremental pitch angle adjustment profile may be changeable according to various operating conditions. For example, the azimuthal position of peak incremental pitch angle adjustment may shift depending upon current rotor speed and/or other factors. A faster rotor speed may dictate a phase shift greater than the exemplary 10° such that the peak pitch command occurs in advance of 170°, or a slower rotor speed may dictate a phase shift less than the exemplary 10° such that the peak pitch command occurs closer to 180°. The starting and termination points for the incremental pitch angle adjustments may also shift as a function of factors such as the rotor speed, wind speed, or power output. In addition, the maximum or peak incremental pitch angle adjustment may vary depending upon any of the aforementioned factors or other factors. For example, at lower power outputs and greater nominal pitch angles, the maximum or peak incremental pitch command may be decreased because less unloading of the tower-crossing blade to promote enhanced tip to tower clearance is necessary. For example, if the nominal pitch angle is, say 15 to 20°, instead of 5 to 10° which was assumed in the example of FIG. 4, the maximum or peak amount of pitch angle adjustment provided to feather the tower-crossing blade could be 1° rather than a maximum of about 3°.

The control algorithm outlined above may be utilized in addition to and/or may be superimposed upon any other existing or in-place control function for determining pitch angles. For example there may be a basic closed loop control function already in place that addresses wind velocity and direction, including feedback calling for pitch changes to avoid overloading. The disclosed control algorithm may thus be adapted to work in concert with such pre-existing closed loop control systems.

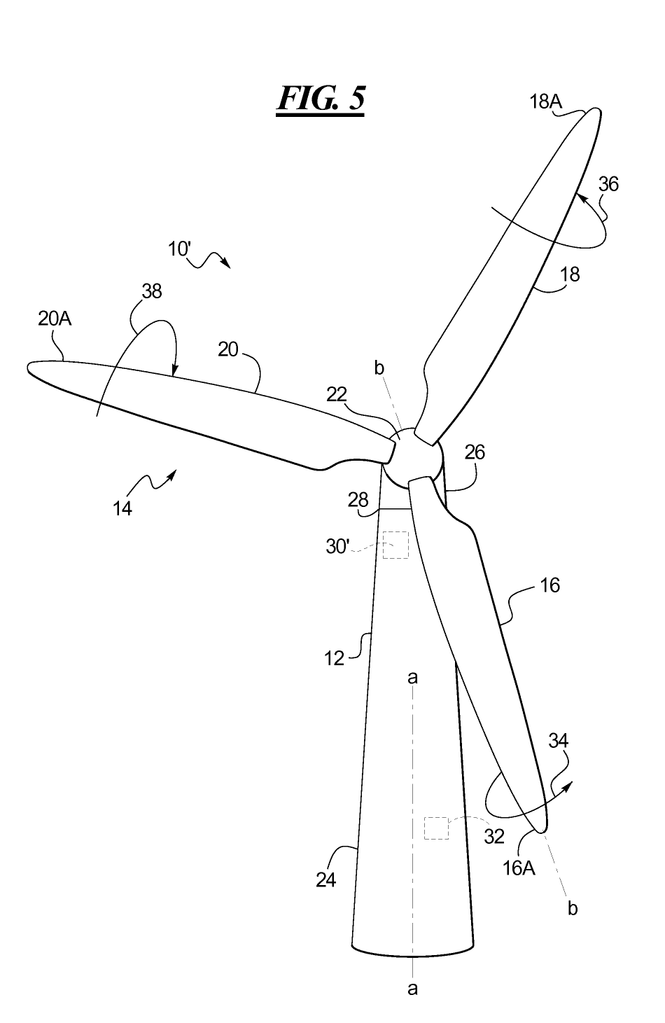

FIG. 5 depicts a different blade algorithm for an alternative control system 30′. As already described with respect to the wind turbine 10, the wind turbine 10′ of FIG. 5 includes the same capability for individually feathering any given tower-crossing blade. However, the control system 30′ is additionally adapted to cause each of the non-tower-crossing blades to over-pitch to compensate for the loss of torque and power associated with the feathering of the tower-crossing blade. The alternative control system 30′ may be a separate control function, or may be an added-on part of the above-described control system 30. The torque arrows 36 and 38, displayed around the tips 18A and 20A of the non-tower-crossing blades 18 and 20, respectively, indicate that each of those blades is moving into an over-pitch position to compensate for the torque loss of the feathering blade 16.

### INDUSTRIAL APPLICABILITY

The present disclosure generally sets forth a control methodology for modifying the pitch angles of rotor blades of utility scale wind turbines to achieve or enhance desired margins of safety for blade tip to tower clearance. The control methodology may offer a wind turbine designer additional methods or tools to achieve required margins of safety for blade tip to tower clearance. The control methodology may further result in designs of lighter blades, or longer and more flexible blades, and/or other beneficial outcomes.

Individual feathering of the tower-crossing blade may be combined with other pitch adjustments to the non-tower-crossing blades to achieve different effects. In one example, the non-tower-crossing blades may be pitched toward power while the tower-crossing blade is being feathered. In this manner, the total amount of torque on the rotor generated collectively by the blades may thus be maintained more evenly, and the power output may experience less fluctuation.

Finally, the feathering of the tower-crossing blade may be controlled in large part as an azimuthal function of the position of the rotor. As such, the control algorithm may be an open loop function, rather than a feedback or closed loop function, utilizing encoder generated signals that reflect real-time positions of the tower-crossing blade with respect to the tower base.

We claim:

1. A method of increasing the clearance between a blade tip and a base of a tower for tower-crossing rotor blades of a wind turbine having a tower and a plurality of wind-driven rotatable blades supported thereon, comprising:
a) providing a control system adapted to feather individual blades of said plurality of blades;
b) providing an azimuthal encoder for electronic communication with said control system;
c) having the azimuthal encoder provide input to said control system to sense the approach of any one of said plurality of blades to said base in real-time; and,
d) having the control system respond to said encoder input by feathering each said approaching tower-crossing blade as a function of a sensed azimuthal position of said blade.

2. The method of claim 1, wherein said control system returns said blade to a power pitch position after said blade has traveled beyond said tower base.

3. The method of claim 1, wherein said control system is adapted to initiate said feathering of said approaching blade at a predetermined azimuthal position.

4. The method of claim 1, wherein said control system response to said azimuthal position is calculated by said control system as a function of operating conditions, including rotor speed.

5. The method of claim 2, wherein a maximum incremental pitch angle adjustment is a function of current operating conditions.

6. The method of claim 1, wherein said control system response to said azimuthal position is also a function of current operating conditions.

7. The method of claim 2, wherein said control system is adapted to have the blade fully returned to said power pitch position at a predetermined azimuthal position.

8. The method of claim 3, wherein said predetermined azimuthal position of said approaching blade is within a target range of 100° to 160°.

9. The method of claim 7, wherein said predetermined azimuthal position of said blade is within a target range of 200° to 260 °.

10. The method of claim 1, wherein said control system is an open loop system based on the azimuthal position of the blade being feathered.

11. The method of claim 1 wherein a peak incremental pitch angle adjustment occurs at an azimuthal position of less than 180°.

12. A method of increasing the clearance between a blade tip and a base of a tower for tower-crossing rotor blades of a wind turbine having a tower and a plurality of wind-driven rotatable blades supported thereon, comprising:
a) providing a control system adapted to feather individual blades of said plurality of blades;
b) providing an azimuthal encoder for electronic communication with said control system;
c) having the azimuthal encoder provide input to said control system to sense the azimuthal position of the blades;
d) having the control system respond to said encoder input by feathering each said approaching tower-crossing blade as a function of a sensed azimuthal position of said blade; and,
e) having the control system respond to said encoder input by over-pitching the remaining, non-tower crossing, blades as each tower-crossing blade is feathered, to compensate for loss of torque attributable to the feathering of the tower crossing blade.

13. The method of claim 12, wherein said control system returns said tower-crossing blade to a power pitch position after said blade has traveled beyond said tower base.

14. The method of claim 12, wherein said control system is adapted to initiate said feathering of said approaching blade at a predetermined azimuthal position.

15. The method of claim 13, wherein said control system is adapted to have the blade fully returned to said power pitch position at a predetermined azimuthal position.

16. The method of claim 14, wherein said predetermined azimuthal position of said approaching blade is within a target range of 100° to 160°.

17. The method of claim 15, wherein said predetermined azimuthal position of said blade is within a target range of 200° to 260°.

18. The method of claim 12, wherein said control system is an open loop system based on azimuthal position of the blade being feathered.

19. The method of claim 12 wherein a peak incremental pitch angle adjustment occurs at an azimuthal position of less than 180°.
